(19) United States
(12) Patent Application Publication
(10) Pub. No.: US 2018/0093411 A1
(43) Pub. Date: Apr. 5, 2018

(54) ADDITIVE MANUFACTURING OF POLISHING PADS ON A CONVEYOR

(71) Applicant: Applied Materials, Inc., Santa Clara, CA (US)

(72) Inventors: Hou T. Ng, Campbell, CA (US); Nag B. Patibandla, Pleasanton, CA (US); Sivapackia Ganapathiappan, Los Altos, CA (US)

(21) Appl. No.: 15/717,617

(22) Filed: Sep. 27, 2017

Related U.S. Application Data
(60) Provisional application No. 62/402,744, filed on Sep. 30, 2016.

(51) Int. Cl. B29C 64/112; B24B 37/20; B24B 37/24; B29C 41/02; B29C 64/245; B29C 64/264; B33Y 10/00; B33Y 30/00; B33Y 80/00

(52) U.S. Cl. CPC B29C 64/112; B24B 37/20; B24B 37/24; B29C 41/02; B29L 2031/736; B29C 64/264; B33Y 10/00; B33Y 30/00; B33Y 80/00; B29C 64/245

(57) ABSTRACT

An apparatus for fabricating a polishing pad includes a conveyor belt, a casting station to form a layer of the polishing pad and to deliver the layer of the polishing pad onto the conveyor belt, a printing station including one or more printheads configured to deposit one or more layers to form a polishing pad, a motor to drive the conveyor belt, and an energy source. The one or more printheads include a plurality of nozzles configured to eject droplets of a liquid polishing pad material precursor on the layer formed by the casting station. The motor drives the conveyor belt while the one or more printheads eject the droplets such that droplets provide a layer of polishing pad material precursor. The energy source at least partially cure the pad material precursor to form a solidified layer of polishing pad material.

### CROSS-REFERENCE TO RELATED APPLICATIONS

This application claims priority to U.S. Application Ser. No. 62/402,744, filed on Sep. 30, 2016, the disclosure of which is incorporated by reference.

### TECHNICAL FIELD

This disclosure relates to additive manufacturing, and particularly additive manufacturing of a polishing pad.

### BACKGROUND

An integrated circuit is typically formed on a substrate by the sequential deposition of conductive, semiconductive, or insulative layers on a silicon wafer. A variety of fabrication processes require planarization of a layer on the substrate. For certain applications, e.g., polishing of a metal layer to form vias, plugs, and lines in the trenches of a patterned layer, an overlying layer is planarized until the top surface of a patterned layer is exposed. In other applications, e.g., planarization of a dielectric layer for photolithography, an overlying layer is polished until a desired thickness remains over the underlying layer.

Chemical mechanical polishing (CMP) is one accepted method of planarization. This planarization method typically requires that the substrate be mounted on a carrier head. The exposed surface of the substrate is typically placed against a rotating polishing pad. The carrier head provides a controllable load on the substrate to push it against the polishing pad. A polishing liquid, such as slurry with abrasive particles, is typically supplied to the surface of the polishing pad.

One objective of a chemical mechanical polishing process is polishing uniformity. If different areas on the substrate are polished at different rates, then it is possible for some areas of the substrate to have too much material removed (“overpolishing”) or too little material removed (“underpolishing”). In addition to planarization, polishing pads can be used for finishing operations such as buffing.

Some polishing pads include “standard” pads and fixed-abrasive pads. A standard pad has a polyurethane polishing layer with a durable roughened surface, and can also include a compressible backing layer. In contrast, a fixed-abrasive pad has abrasive particles held in a containment media, and can be supported on a generally incompressible backing layer.

Polishing pads are typically made by molding, casting or sintering polyurethane materials. In the case of molding, the polishing pads can be made one at a time, e.g., by injection molding. In the case of casting, the liquid precursor is cast and cured into a cake, which is subsequently sliced into individual pad pieces. These pad pieces can then be machined to a final thickness. Grooves can be machined into the polishing surface, or be formed as part of the injection molding process.

### SUMMARY

This specification describes technologies relating to printing polishing pads.

In one aspect, an apparatus for fabricating a polishing pad includes a conveyor belt, one or more printheads configured to deposit one or more layers on the conveyor belt to form a polishing pad, a motor to drive the conveyor belt, and an energy source. The one or more printheads include a plurality of nozzles configured to eject droplets of a liquid polishing pad material precursor on the conveyor belt, and the plurality of nozzles span an entire width of the conveyor belt corresponding to a polishing pad. The motor drives the conveyor belt while the one or more printheads eject the droplets such that droplets provide a layer of polishing pad material precursor. The energy source at least partially cures the pad material precursor to form a solidified layer of polishing pad material.

In another aspect, an apparatus for fabricating a polishing pad includes a conveyor belt, a casting station to form a layer of the polishing pad and to deliver the layer of the polishing pad onto the conveyor belt, a printing station including one or more printheads configured to deposit one or more layers to form a polishing pad, a motor to drive the conveyor belt, and an energy source. The one or more printheads include a plurality of nozzles configured to eject droplets of a liquid polishing pad material precursor on the layer formed by the casting station. The motor drives the conveyor belt while the one or more printheads eject the droplets such that droplets provide a layer of polishing pad material precursor. The energy source at least partially cure the pad material precursor to form a solidified layer of polishing pad material.

Implementations of any of the above aspects may include one or more of the following features.

The one or more printheads may be configured to deposit an initial layer of the one more layers directly on conveyor belt. A substrate may be carried by the conveyor belt, and the one or more printheads may be configured to deposit an initial layer of the one more layers directly on the substrate. The substrate may be a metal, glass, plastic, ceramic or composite material. The substrate may be a disc.

A casting station may form a layer of the polishing pad and to deliver the layer of the polishing pad onto the conveyor belt or the substrate. The one or more printheads may be configured to deposit an initial layer of the one more layers directly on the layer of the polishing pad. The casting station may include a roller carrying a liquid form of a layer of the polishing pad. The casting station may include a second radiation source to cure the liquid.

The apparatus may include a supply of the liquid polishing pad material precursor. The liquid polishing pad material precursor may be a liquid polymer. The liquid polishing pad material precursor may include a monomer, such as a polyurethane monomer or an acrylate monomer.

The energy source may include a UV radiation source. The UV radiation source may include a first UV radiation source to generate a first wavelength of UV light and a second UV radiation source to generate a second wavelength that is longer than the first wavelength. The second UV radiation source may be located after the first UV radiation source along a direction of motion of the conveyor belt.

The energy source may include a radiative heat source. The energy source may be an oven. An oven may be located after the energy source along a direction of motion of the conveyor belt. The energy source may be configured to partially cure the pad material precursor and the oven may be configured to complete curing of the pad material precursor.

An inspection station may be positioned over the conveyor and after the energy source along a direction of motion of the conveyor belt. The conveyor belt may be stainless steel or polyimide. The one or more printheads include a plurality of printheads arranged in a staggered pattern along a width of the conveyor belt. The one or more printheads may provide a plurality of printheads arranged in a successively along the direction of motion of the conveyor belt. The plurality of printheads may be configured to deposit a plurality of successive layers of the polishing pad. The plurality of successive layers of the polishing pad may be no more than five layers.

In another aspect, a method of fabricating a polishing pad includes forming a lower portion of the polishing pad by casting, and printing an upper portion of the polishing pad on the lower portion.

Advantages of the foregoing may include, but are not limited to, the following.

Polishing pads can be manufactured with increased throughput. The disclosed apparatus allows for on-site and on-demand manufacturing of polishing pads in clean-room conditions. On-site manufacturing allows semi-conductor fabricators to print new pads as necessary and to desired specifications. Such a system allows a facility to keep inventory low and only produce products as needed. On demand parts manufacturing also helps prevent costly delays that can occur if there is a lost or delayed shipment of pads from an outside source. The system can provide fast turn-around time for customized polishing pad designs.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a schematic top view of a polishing pad.

FIG. 1B is a schematic side view of the polishing pad of FIG. 1A.

FIG. 1C is a schematic side view of a polishing apparatus.

FIG. 2 is a schematic top-down view of an example additive manufacturing apparatus for printing polishing pads.

FIG. 3 is a schematic side view of an example polishing pad going through an example casting station.

FIG. 4 is a schematic side view of an example polishing pad being printed in an example printing station.

FIGS. 4A-4C are schematic top views of example printing stations.

FIGS. 5A-5C are schematic side views showing an example of a printing medium curing under energy sources.

FIG. 6 is a schematic side view showing an example polishing pad being cured in an example annealing station.

Like reference numbers and designations in the various drawings indicate like elements.

### DETAILED DESCRIPTION

Additive manufacturing (AM), also known as solid freeform fabrication or 3D printing, refers to any manufacturing process where three-dimensional objects are built up from raw material (generally powders, wire, liquids, suspensions, or molten solids) in a series of two-dimensional layers or cross-sections. In contrast, traditional machining techniques involve subtractive processes and produce objects that are cut out of a stock material such as a block of wood or metal.

A variety of additive processes can be used in additive manufacturing. The various processes differ in the way layers are deposited to create the finished objects and in the materials that are compatible for use in each process. Some methods melt or soften material to produce layers, e.g., selective laser melting (SLM) or direct metal laser sintering (DMLS), selective laser sintering (SLS), fused deposition modeling (FDM), while others cure liquid materials using different technologies, e.g. stereolithography (SLA).

Stereolithography is an additive manufacturing process that works by focusing an ultraviolet (UV) laser onto a vat of photopolymer resin. With the help of computer aided manufacturing or computer aided design software (CAM/CAD), the UV laser is used to draw a pre-programmed design or shape on to the surface of the photopolymer vat. Because photopolymers are photosensitive under ultraviolet light, the resin is solidified and forms a single layer of the desired 3D object. This process is repeated for each layer of the design until the 3D object is complete.

As a higher manufacturing throughput is required for 3D objects, it becomes more difficult to utilize additive manufacturing techniques to meet demands. Often 3D objects manufactured with an additive process are constructed one object at a time. Depending on the additive manufacturing technique used, the additive manufacturing facilities may need to be cleaned or prepped for the next part to be manufactured. The combination of single object manufacturing and turn-over time between parts makes typical additive manufacturing techniques suitable for only small batch parts.

An additive manufacturing apparatus can be configured to include a conveyor belt and multiple additive manufacturing stations along the conveyor belt. This can be achieved with earlier stations performing “course” manufacturing techniques, that is, adding more material with less precision, and later stations performing “finer” manufacturing techniques, that is, adding less material with more precision.

The additive manufacturing apparatus can also include finishing stations. Finishing stations can include curing stations for liquid based additive manufacturing, such as stereo lithography, or include heat-treating stations for metallic based additive manufacturing techniques. The additive manufacturing apparatus can also include one or more metrology systems that measure various parameters of the additive manufacturing process, for example, thermal/temperature uniformity, surface roughness or uniformity, image the surface, and/or stress of the deposited feed material.

In some instances, it is desirable to manufacture substantially thin items (often less than or equal to five successive layers of printing medium thick) with the methods discussed above. When thin items need to be printed, far less vertical clearance is needed for manufacturing. An example of a thin item that might use this process is a chemical-mechanical planarization (CMP) polishing pad, such as those used in semi-conductor manufacturing.

With the disclosed additive manufacturing apparatus, it is possible to manufacture polishing pads on-site in clean-room conditions. On-site manufacturing allows semi-conductor fabricators to print new pads as necessary and to specifications that they desire. Such a system allows a facility to keep inventory low and only produce products as needed.

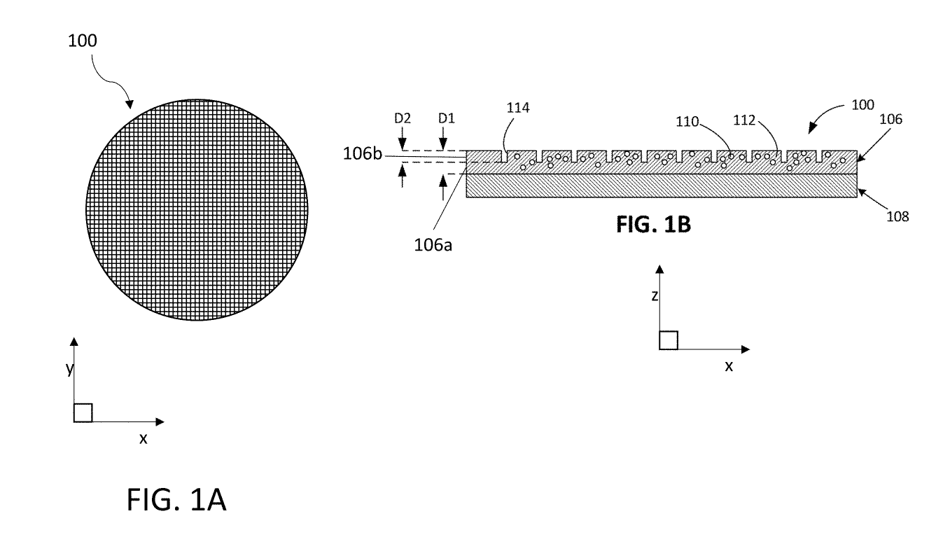

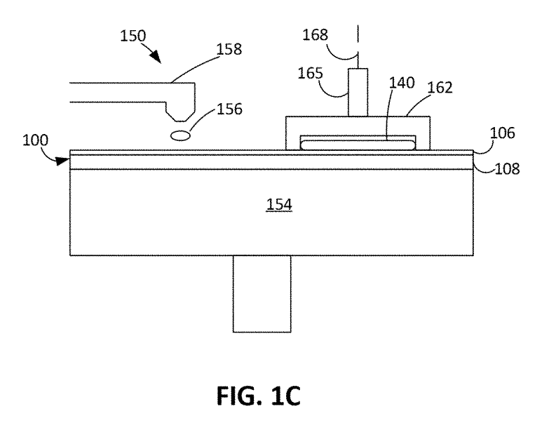

FIG. 1A shows a top-down view of an example polishing pad 100. The pad can be circular and can range in size from about 20 to 45 inches in diameter. FIG. 1B shows a side view of the example polishing pad 100. The polishing pad 100 can have one or more grooves arranged in various patterns to allow fluid flow during polishing operations. The pattern produced on the surface of polishing pad 100 can vary depending on the intended polishing application.

In an example of a polishing pad 100 depicted in FIGS. 1A and 1B, the polishing pad 100 is a multi-layer pad. The polishing pad 100, for example, includes a polishing layer 106 and a backing layer 108. The polishing layer 106 is formed of a material that is, for instance, inert to the polishing process. The material of the polishing layer 106 can be a plastic, e.g., a polyurethane or acrylate. The polishing layer 106 has a hardness of, for example, about 40 to 80, e.g., 50 to 65, on the Shore D scale.

In some implementations, the polishing layer 106 is a layer of homogeneous composition. The polishing layer 106 can include pores 110 suspended in a matrix 112 of plastic material, e.g., polyurethane. The pores 110 can be provided by hollow micro-spheres suspended in the matrix 112, by voids in the matrix 110 itself, or by regions of water-soluble material suspended in the matrix.

In some implementations the polishing layer 106 includes abrasive particles held in the matrix 112 of plastic material. The abrasive particles are harder than the material of the matrix 112. The material of the abrasive particles can be a metal oxide, such as ceria, alumina, silica or a combination thereof.

In some implementations, the polishing layer 106 has a thickness D1 of 80 mils or less, e.g., 50 mils or less, e.g., 25 mils or less. Because the conditioning process tends to wear away the cover layer, the thickness of the polishing layer 106 can be selected to provide the polishing pad 100 with a useful lifetime, e.g., 1000 polishing and conditioning cycles.

In some implementations, the polishing layer 106 includes grooves 114 for carrying slurry. The grooves 114 form a pattern, such as, for example, concentric circles, straight lines, a cross-hatched, spirals, and the like. If grooves are present, the plateaus between the grooves 114 are, for example, approximately 25-90% of the total horizontal surface area of the polishing pad 100. The grooves 114 occupy, for example, approximately 10%-75% of the total horizontal surface area of the polishing pad 100. The plateaus between the grooves 160 can have a lateral width of about 0.1 to 2.5 mm.

In some implementations, e.g., if there is a backing layer 108, the grooves 114 extend entirely through the polishing layer 106. In some implementations, the grooves 114 extend through about 20-80%, e.g., 40%, of the thickness of the polishing layer 106. The depth of the grooves 114 is, for example, 0.25 to 5 mm or 0.25 to 1 mm. In some cases, for example, in a polishing pad 100 having a polishing layer 106 that is 50 mils thick, the grooves 114 have a depth D2 of about 20 mils.

In some implementations, the backing layer 108 is softer and more compressible than the polishing layer 106. The backing layer 108 has, for instance, a hardness of 80 or less on the Shore A scale, e.g., a hardness of about have a hardness of 60 Shore A. The backing layer 108 can be thicker or thinner or the same thickness as the polishing layer 106.

The polishing pad 100 can be used to polish one or more substrates at a polishing apparatus. A description of a suitable polishing apparatus can be found in U.S. Pat. No. 5,738,574. In some implementations, referring to FIG. 1C, a polishing system 150 includes a rotatable platen 154 on which the polishing pad 100 is placed. During a polishing operation, a polishing liquid 156, e.g., an abrasive slurry, is dispensed on the surface of the polishing pad 100 by a polishing liquid supply port 158, which can be combined with a rinse arm. The polishing liquid 156, in some cases, contains abrasive particles, a pH adjuster, or chemically active components.

In some implementations, to polish a substrate 140, the substrate 140 is held against the polishing pad 100 by a carrier head 162. The carrier head 162 is suspended from a support structure, such as a carousel, and is connected by a carrier drive shaft 164 to a carrier head rotation motor so that the carrier head can rotate about an axis 166. The relative motion of the polishing pad 110 and the substrate 140 in the presence of the polishing liquid 166 results in polishing of the substrate 210.

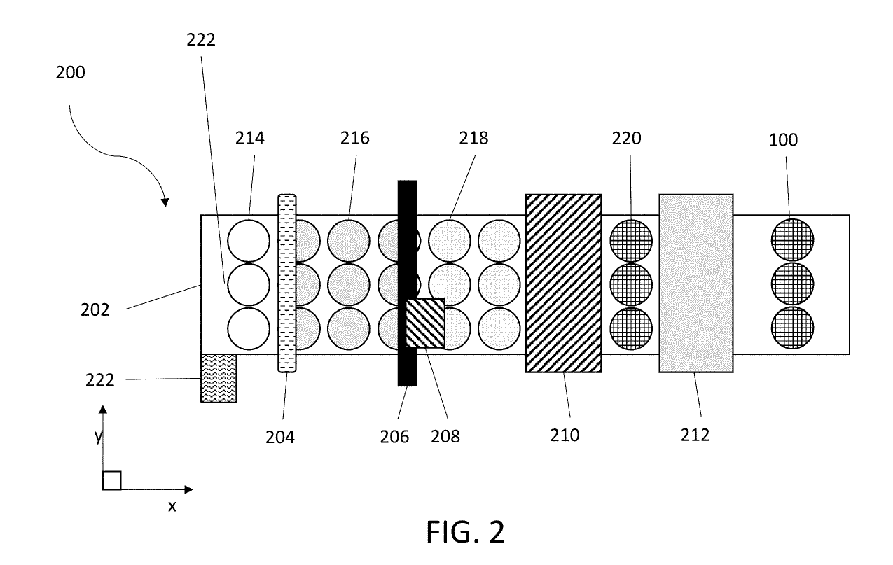

FIG. 2 shows a top-down view an example additive manufacturing apparatus 200 used to print articles, e.g., polishing pads 100 for use in semi-conductor manufacturing. The additive manufacturing apparatus 200 includes a conveyor belt 202, a motor 222 to drive the conveyor belt 202, a casting station 204, a printing station 206, and a controller 208. The additive manufacturing apparatus 200 can also include an annealing station 210 and an inspection station 212.

The conveyor belt 202 transports a substrate 214 (e.g., in the direction shown by arrow A) on which the polishing pad will be fabricated through the printing process until a completed polishing pad 100 is produced. The conveyor belt 202 carries the substrate 214 to each station in the following order: the casting station 204, the printing station 206, the annealing station 210, and the inspection station 212. The conveyor belt 202 can be constructed of stainless steel, polyimide, or other suitable material.

The additive manufacturing process starts with a substrate 214 being placed, e.g., by the operator or by a robot, at a starting position 222 on the conveyor belt 202. The substrate 214 can be the same shape (in a top view) as the article to be fabricated. For example, for a circular polishing pad the substrate 214 can be disk-shaped. The substrate 214 can be a metal, glass, plastic, ceramic or composite body.

The additive manufacturing apparatus 200 includes a liquid feed system 320 to supply a liquid feed material that will be solidified to form the article, e.g., the polishing pad. Thus, the liquid feed material can be a pad precursor for printing of the polishing pad. The liquid pad precursor can be formed of one or more polymers and/or monomers, e.g., a urethane monomer or an acrylate monomer. The same feed material could be supplied to both the casting station 204 and the printing station 206, or the liquid feed system 320 could supply different liquid feed materials to the casting station 204 and the printing station 206.

The liquid feed system 320 can include one or more reservoirs 312 to hold the liquid feed material(s). The liquid feed material can be fed from the reservoir 312 to the printing station 206 and/or the casting station 204 with conventional pumps 314 and tubing 316. The controller 208 can control the flow rate of the liquid feed material and the duty cycle of any pump that is causing liquid feed material to flow to the additive manufacturing apparatus 200.

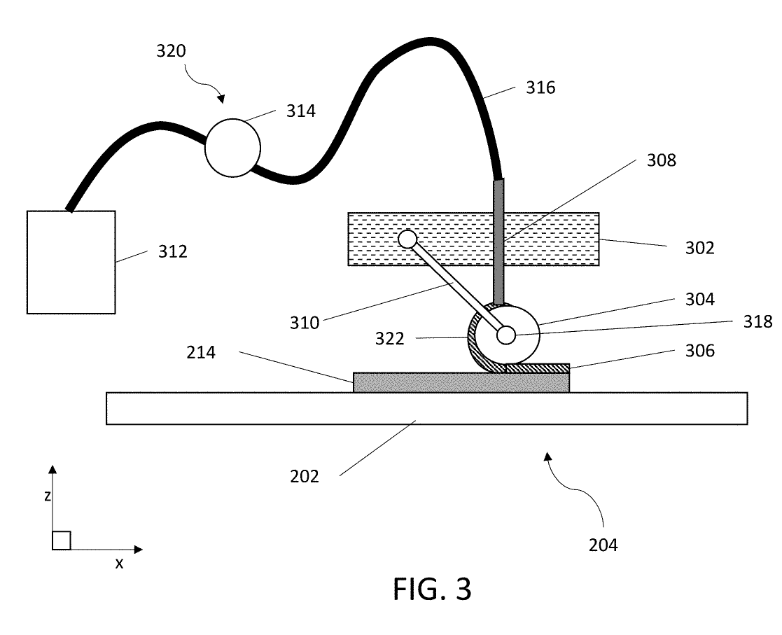

The conveyor belt 202 carries the substrate 204 into the casting station 204, which can be the first station that the substrate 214 enters. FIG. 3 shows a side view of an example casting station 204. The casting station 204 includes a roller 304 that extends the entire width of the conveyor belt 202. The roller 304 can be free to rotate, or can be connected to a motor 318 that can drive the roller 304. A conduit 308 from the liquid feed system 320 can be configured to dispense the liquid feed material onto the outer surface of the roller 304. Optionally, a blade can be used to smooth the casting layer 306 after it has been delivered onto the substrate. In some implementations, the roller is replaced with a blade coater.

The roller 304 is held by a support 302, such as a gantry, a cantilever arrangement, or a frame extending over the conveyor belt. The support 302 can suspend the roller 304 over the conveyor belt 202 in a position that, at the bottom of the roller 304, the layer of liquid feed material 322 will contact and be transferred to the support 302. As the belt 202 moves (e.g., in the direction shown by arrow A), the casting layer 306 of feed material is deposited. However, the roller 304 can be positioned at a sufficient height that the roller 302 does not contact the conveyor belt 202 and thus the feed material 322 is not transferred to the belt 202.

In some implementations, the roller 304 is coupled to the support 302 by two support struts 310 that are rotatably connected to opposite ends of the roller 304. An actuator can be coupled to the support struts 310 to control the vertical position of the roller 304 relative to the conveyor belt 202. Alternatively or in addition, the support struts 310 can be coupled to a damping system to reduce vibration.

As noted above, the roller 304 is configured to apply the liquid feed material to the substrate 214 to form a casting layer 306 on the substrate 214, which provides an initial layer of the article being fabricated, e.g., a bottom layer of a polishing pad. The casting layer 306 is the first step in the printing process and subsequent layers will be built on top of the casting layer 306.

The casting layer 306 can be a substantial portion of the entire thickness of the article being fabricated, e.g., 30% to 80%, e.g., 50% to 75% of the total thickness of the article. In some implementations, the casting layer 306 provides all of the polishing layer 106 below the grooves 114 (see FIG. 1B), e.g., the thickness of the casting layer 306 is D1-D2.

The casting layer 306 can be applied, e.g., by the roller 304, in a continuous sheet on the substrate 214. The casting layer 306 can be applied in a continuous elongated stripe that sweeps across the substrate 214. For example, the casting layer 306 can be applied across the entire width of the substrate 214. In addition, the casting layer 306 can be applied in a “non-selective” manner, i.e., the casting station isn't configured to receive signals that will control which portions of the substrate 214 receive the layer 306.

The coated material of the casting layer 306 can be partially or fully cured before it is being carried to the printing station 206. Curing can be performed by infrared, visible or ultraviolet radiation, or a combination thereof, and the curing mechanism can be integrated into the casting station 204 or be a separate station positioned between the casting station and printing station 206.

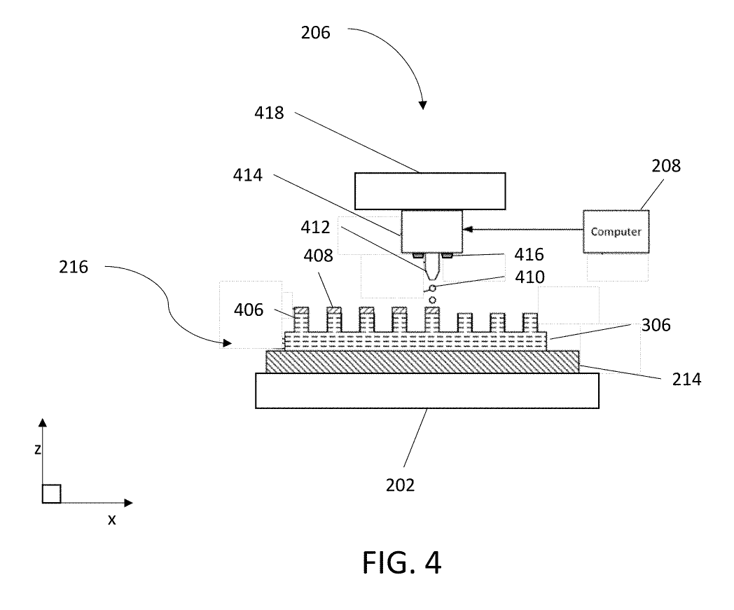

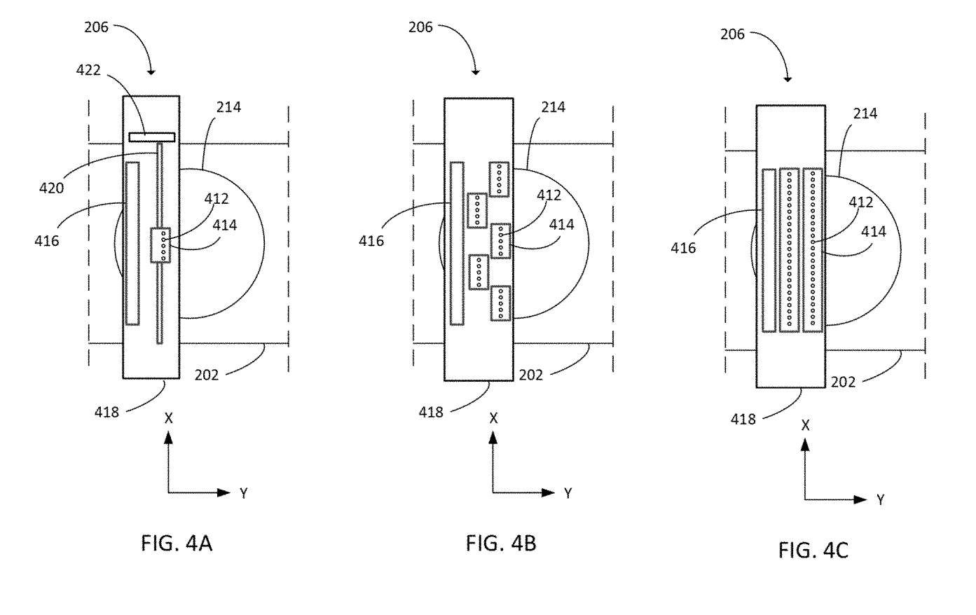

The conveyor belt 202 next carries the substrate 214 to the printing station 206. FIG. 4 shows a thin article 216, e.g., a cast polishing pad, in the process of going through printing station 206. The printing station 206 includes one or more printheads 414 each having one or more nozzles 412. The printing station 206 can also include a support 418 to hold the printhead 414, and a radiation source 416 to partially or fully cure the liquid feed material dispensed over the casting layer 306. The multiple printheads 414 allow for a greater throughput than a single printhead 414 is capable of producing.

It is desirable to have a standardized printhead 414 that can include various components, such as, a feed material dispenser, a heat source and an energy source. “Standardized” in this context indicates each printhead 414 is substantially identical in physical configuration (there can be software exceptions such as serial number or firmware version that vary between dispensers). The standardized printhead 414 simplifies construction and repair of the additive manufacturing apparatus 200.

In some implementations the support 418 is a gantry suspended on supports, e.g., two posts, that are arranged on opposite sides of the conveyor belt 202. Alternatively the support 418 can be held in a cantilever arrangement on just one side of the belt 202.

In some implementations, e.g., as shown in FIG. 4A, the nozzles of the printhead 414 are not arranged to span the width of the substrate 214 and/or the width of the conveyor belt 202. In this case, the printhead 414 is able to move along the support 418 on a horizontal axis perpendicular to the direction of motion of the conveyor belt 202 transporting the article. For example, the support 418 could include a linear guide 420, e.g., a rail, that extends along the X-axis, and a linear actuator 422 could drive the printhead 414 along the linear guide on the X-axis. In some implementations, the printhead 414 can move parallel to the direction of motion of the conveyor belt 202.

In some implementations, the printheads 414 can be removably mounted on a support to form a printhead assembly. The printhead assembly can include mechanisms, for example, actuators, that allow the printheads 414 to move relative to one another. In addition, the printhead 414 can include mechanisms, for example, actuators, that allow the components in the printhead 414 to move relative to one another.

In some implementations, e.g., as shown in FIG. 4B, the nozzles 412 of one or more printheads 414 are arranged to span the width of the substrate 214 and/or the width of the conveyor belt 202. In this case, the support 418 can remain fixed in place while the conveyor belt 202 moves below the printheads 414. In some implementations, multiple printheads 414 and nozzles 412 can be arranged in a staggered pattern across a width of the conveyor.

In some implementations, e.g., as shown in FIG. 4C, multiple printheads 414 and nozzles 412 can be arranged successively along the direction of motion of the conveyor 202 (e.g., the Y-axis). This permits multiple layers 408 to be deposited successively as the substrate 214 passes through the printing station 206.

Alternatively, to deposit multiple layers 408 in the printing station, the support 418 could be configured to move back and forth along the axis of motion of the conveyor belt 202, e.g., along the Y-axis. For example, the support 418 could be suspended from a rail that extends along the Y-axis, and a linear actuator could drive the support 418 along the rail, thus carrying the printhead 414 along the Y-axis. Alternatively, the conveyor belt 202 could be driven backward and forward in an alternating fashion to carry the substrate 214 past the printhead 414 multiple times.

Each printhead 414 can be configured to eject droplets 410 of the feed material unto the underlying layer, e.g., the casting layer 306 or a layer previously deposited at the printing station 206. Each printhead 414 regulates the flow rate and droplet size of the liquid feed material, e.g., the polishing pad material precursor, while the substrate 214 moves past the printhead 414 to add a new layer 408 of pad precursor droplets 410.

The radiation source 416 can be configured to partially cure the feed material in an area that extends across the conveyor belt 202. The radiation source 416 can be, for example, an array of heat lamps.

Each layer 408 can be cured by a radiation source 416 as it is deposited. The radiation source 416 partially cures the pad material precursor to form a partially solidified layer 406 of polishing pad material that is strong enough to support the next layer.

In fabrication of thin objects, only a limited number of layers 408 need be deposited, e.g., one-hundred layers or less, e.g., ten layers or less, e.g., two to five layers, e.g., two or three layers.

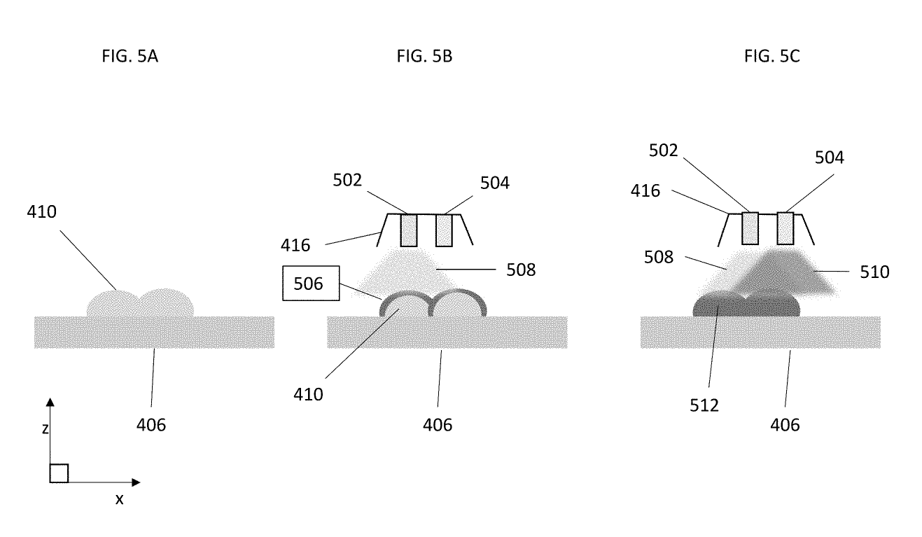

FIGS. 5A-5C are schematic diagrams of an example curing process that can take place at the printing station 206. FIG. 4A shows two droplets 410 deposited as a layer on top of a previously cured layer 406. The droplets are exposed to at least one radiation, e.g., visible light, heat, or UV radiation from the radiation source 416.

As shown in FIG. 4B, the radiation source 416 can include multiple radiation emitters emitting different wavelengths of radiation. For example, as shown in FIG. 4C, the radiation source 416 can have a first light source 502, e.g., a set of one or more first LEDs, that emits a first radiation 508, and a second light source 504, e.g., a set of one or more second LEDs, that emit a second radiation 510. In this example, the first radiation 508 can be a ultraviolet (UV) light having a first wavelength and the second radiation 510 can be UV light having a second wavelength that is longer than the first wavelength. The first light source 502 can be positioned before the second light source 504 along the direction of motion of the conveyor belt 202. The wavelength band of the second radiation 510 can be wider than the wavelength band of the first radiation 500.

The first light source 502 can be configured to harden the outer surface 506 on the droplets 410; the shorter wavelength of the first radiation 508 does not penetrate deeply into the droplets 410 so the outer surface 506 of droplets 410 is cured preferentially. The second light source 504 can be configured to harden the interior 512 of the droplets 410; the longer wavelength of the second radiation 510 can penetrate into the interior 512 of droplets 410 to provide curing. The first light source 504 and the second light source 502 can be used sequentially or in parallel to achieve the desired results from printing station 206. Once the remaining layers are printed and cured on the casting substrate, then a printed polishing pad 218 is carried from the printing station 206 to the annealing station 210 by the conveyor belt 202.

In some implementations, rather than multiple light sources, the system includes a single UV light source that emits a wide UV spectrum.

Moreover, the radiation source 416 can be selectively activated in order to selectively cure desired regions of the deposited liquid pad precursor. For example, the radiation source 416 can emit the first radiation 508 or the second radiation 510 that impinges certain portions of the printed layers 406, thereby curing the feed material, e.g., the liquid pad precursor, deposited in that portion. Selective irradiating of certain portions of the feed material by the radiation source 416 can be achieved by moving the radiation source 416 relative to the printhead 414, or by moving the first radiation 508 or the second radiation 510 over the liquid pad precursor, or both, in conjunction with selective activation of the radiation source 416.

For example, the radiation source 416 can move along a direction (e.g., the x-axis) perpendicular to the motion of the printhead 414 module (e.g., the y-axis) by a motor or an actuator that is controlled by the controller 208. In another example, the radiation source 416 may not move relative to the printhead 414. However, the radiation source 416 may include a mechanism, for example, a mirror mounted on a galvo or a piezoelectric micromirror device, which can deflect the first radiation 508 or the second radiation 510 along the direction perpendicular to the direction of motion of the printhead 414 module. The micromirror device may include a linear array of mirrors that are arranged along the direction perpendicular to the direction of motion of the printhead 414 module. In all the aforementioned cases, the position of impingement of the first radiation 508 or the second radiation 510 relative to the liquid pad precursor changes.

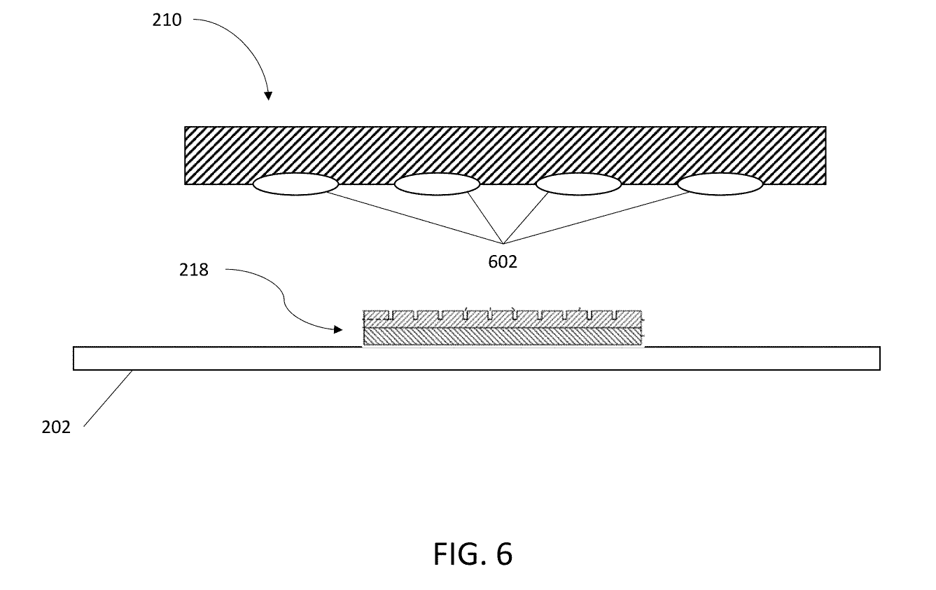

FIG. 6 shows a side view of an example annealing station 210 that includes a large oven with radiative heat sources 602 to finish the curing process of the printed polishing pad 218. The oven is configured to be of sufficient length and temperature to fully cure the printed polishing pads 218 without causing them damage.

The energy delivered to each heat source 602 can be controlled by the controller 208. Changing the energy delivered to each of the heat sources 602 can change the energy radiated by the heat sources 602. Therefore, the spatial distribution of energy generated by the heat sources 602 can be controlled by the controller 208. As a result, the portion of the feed material deposited on the platen that receives energy from the heat source array 602 can have a temperature distribution. In other words, the heat source array 602 can provide control of the temperature distribution of the aforementioned portion of the deposited liquid pad precursor.

Once the printed polishing pads 218 are fully cured, the fully cured pads 220 can be carried by the conveyor belt 202 to the inspection station 212. The fully cured pads 220 are essentially completed when they leave the annealing station 210, but the cured pads 220 can be checked against manufacturing specifications at inspection station 212. The cured pads 220 can be inspected via optical metrology, durometer measurements, thickness measurements, or any other measurements known in the art. Each cured pad 220 can be individually inspected.

The completed and inspected polishing pads 100 can be removed from the substrate, e.g., peeled off the substrate 214. The polishing pad can be sent to a variety of destinations. If a polishing pad 100 does not meet specifications, it is rejected and can be sent for disposal or recycling. If the completed and inspected polishing pads 100 do meet specifications, then the completed and inspected polishing pads 100 can be sent to storage, packaging, directly to a CMP polisher, or otherwise as an operator may need.

The controller 208 controls various aspects of the additive manufacturing apparatus 200. For example, the controller 208 controls the motor 222 and thus the motion of the conveyor belt 202. The controller 208 can also control the printing station 206 and therefore the ejection of droplets from the printhead 414, and if applicable the motion of the printhead 414. The controller 208 can also control the relative motion and operation of multiple printheads 414 included in the printing station 206. The controller can also receive feedback from and/or control the operation of various printing components included in the printhead 414.

The controller 208 and other computing devices part of systems described herein can be implemented in digital electronic circuitry, or in computer software, firmware, or hardware. For example, the controller can include a processor to execute a computer program as stored in a computer program product, e.g., in a non-transitory machine readable storage medium. Such a computer program (also known as a program, software, software application, or code) can be written in any form of programming language, including compiled or interpreted languages, and it can be deployed in any form, including as a standalone program or as a module, component, subroutine, or other unit suitable for use in a computing environment.

The controller 208 and other computing devices part of systems described can include non-transitory computer readable medium to store a data object, e.g., a computer aided design (CAD)-compatible file that identifies the pattern in which the feed material should be deposited for each layer. For example, the data object could be a STL-formatted file, a 3D Manufacturing Format (3MF) file, or an Additive Manufacturing File Format (AMF) file. As another example, the data object could be an image file with one or more layers, e.g., one or more tiff, jpeg formatted images. The controller 208 could receive the data object from a remote computer. A processor in the controller 208, e.g., as controlled by firmware or software, can interpret the data object received from the computer to generate the set of signals necessary to control the components of the additive manufacturing apparatus to cure the specified pattern for each layer.

A number of implementations have been described. Nevertheless, it will be understood that various modifications may be made, as the following.
Although the apparatus has been described in the context of fabrication of a polishing pad, the apparatus can be used for fabrication of other articles by additive manufacturing.
Instead of a roller, the casting layer could be deposited by ejecting droplets from one or more printheads, or poured onto the substrate (or conveyor) and smoothed by a blade.
The article, e.g., the polishing pad, can be fabricated directly on the conveyor belt; in this case the substrate is unnecessary. After fabrication, the article can be separated from the conveyor belt, e.g., by a blade extending across the conveyor belt.
The substrate can form a portion of the article. For example, the substrate can be the backing layer 108 of the polishing pad 100. In this case, the apparatus is used to form the polishing layer 106. Optionally a stiffening layer, e.g., a metal or glass sheet, can underlie the backing layer 108; this stiffening layer is removed once the polishing layer 106 is fabricated.
The apparatus need not include a casting station. For example, a lower portion of the article, e.g., a lower portion of the polishing pad, can be formed by a different process, e.g., injection molding, and the apparatus could be used to form only an upper portion of the article. For example, the portion 106a of the polishing layer 106 up to the bottom of the grooves 114 (see FIG. 1B), could be formed by injection molding or by casting the polishing material in a block and then skiving off a sheet. This lower portion 106a could provide the substrate 214. Then the printing station could be used to form the upper portion 106b having the grooves 114.
The polishing pad 100 need not include a backing layer; it could include just the polishing layer 106.
The additive manufacturing apparatus can be used to manufacture just the polishing layer 106. If the backing layer is desired for the polishing pad, it can be adhesively attached after the polishing layer 106 is formed.
The polishing pads can be removed from the substrate prior to curing in the annealing station, e.g., before being placed into an oven.

In some cases, the actions recited in the claims can be performed in a different order and still achieve desirable results. In addition, the processes depicted in the accompanying figures do not necessarily require the particular order shown, or sequential order, to achieve desirable results.

Accordingly, other implementations are within the scope of the claims.

What is claimed is:

1. An apparatus for fabricating a polishing pad, comprising:
a conveyor belt;
one or more printheads configured to deposit one or more layers on the conveyor belt to form a polishing pad, the one or more printheads comprising a plurality of nozzles configured to eject droplets of a liquid polishing pad material precursor on the conveyor belt, and wherein the plurality of nozzles span an entire width of the conveyor belt corresponding to a polishing pad;
a motor to drive the conveyor belt while the one or more printheads eject the droplets such that droplets provide a layer of polishing pad material precursor; and
an energy source to at least partially cure the pad material precursor to form a solidified layer of polishing pad material.

2. The apparatus of claim 1, wherein the one or more printheads are configured to deposit an initial layer of the one more layers directly on conveyor belt.

3. The apparatus of claim 1, comprising a substrate carried by the conveyor belt, and wherein the one or more printheads are configured to deposit an initial layer of the one more layers directly on the substrate.

4. The apparatus of claim 3, wherein the substrate is a metal, glass, or plastic disc.

5. The apparatus of claim 1, comprising a casting station to form a layer of the polishing pad and to deliver the layer of the polishing pad onto the conveyor belt or the substrate, and wherein the one or more printheads are configured to deposit an initial layer of the one more layers directly on the layer of the polishing pad.

6. The apparatus of claim 5, wherein the casting station comprises a roller carrying a liquid form of a layer of the polishing pad.

7. The apparatus of claim 6, wherein the casting station comprises a second radiation source to cure the liquid form of the layer of the polishing pad.

8. The apparatus of claim 1, wherein the energy source comprises a UV radiation source.

9. The apparatus of claim 8, wherein the UV radiation source comprises a first UV radiation source to generate a first wavelength of UV light and a second UV radiation source to generate a second wavelength that is longer than the first wavelength.

10. The apparatus of claim 9, wherein the second UV radiation source is located after the first UV radiation source along a direction of motion of the conveyor belt.

11. The apparatus of claim 1, wherein the casting station is configured to deliver a liquid form of a layer of the polishing pad along a continuous elongated region.

12. The apparatus of claim 1, wherein the energy source comprises a radiative heat source.

13. The apparatus of claim 1, further comprising an oven located after the energy source along a direction of motion of the conveyor belt, and wherein the energy source is configured to partially cure the pad material precursor and the oven is configured to complete curing of the pad material precursor.

14. The apparatus of claim 1, wherein the energy source comprises an oven.

15. The apparatus of claim 1, comprising an inspection station positioned over the conveyor and after the energy source along a direction of motion of the conveyor belt.

16. The apparatus of claim 1, wherein the one or more printheads comprise a plurality of printheads arranged in a staggered pattern along a width of the conveyor belt.

17. The apparatus of claim 1, wherein the one or more printheads comprise a plurality of printheads arranged in a successively along the direction of motion of the conveyor belt.

18. The apparatus of claim 17, wherein the plurality of printheads are configured to deposit a plurality of successive layers of the polishing pad.

19. An apparatus for fabricating a polishing pad, comprising:
a conveyor belt;
a casting station to form a layer of the polishing pad and to deliver the layer of the polishing pad onto the conveyor belt;
a printing station including one or more printheads configured to deposit one or more layers to form a polishing pad, the one or more printheads comprising a plurality of nozzles configured to eject droplets of a liquid polishing pad material precursor on the layer formed by the casting station;
a motor to drive the conveyor belt while the one or more printheads eject the droplets such that droplets provide a layer of polishing pad material precursor; and
an energy source to at least partially cure the pad material precursor to form a solidified layer of polishing pad material.

20. A method of fabricating a polishing pad, comprising:
forming a lower portion of the polishing pad by casting; and
printing an upper portion of the polishing pad on the lower portion.
